(19) United States
(12) Patent Application Publication
(10) Pub. No.: US 2006/0059781 A1
(43) Pub. Date: Mar. 23, 2006

(54) Power supply for window regulator motor

(75) Inventors: Louis William Berklich JR., Lake Orion, MI (US); Jose Maria Garcia, Troy, MI (US)

Correspondence Address: WILLIAM M HANLON, JR;YOUNG & BASILE, PC, 3001 WEST BIG BEAVER ROAD, SUITE 624, TROY, MI, 48084-3107, US

(73) Assignee: HI-LEX Corporation, Troy, MI (US)

(21) Appl. No.: 10/945,083

(22) Filed: Sep. 20, 2004

(51) Int. Cl. E05F 11/48

(52) U.S. Cl. 49/352

(57) ABSTRACT

A motor vehicle door window glass regulator of the type including a carrier for mounting the window glass and mounted for reciprocal movement to move the window glass between raised and lowered positions, an electric motor carried by the carrier, and a cable device driven by the motor and operative in response to actuation of the motor to move the carrier reciprocally and thereby move the window glass between its raised and lowered positions. The electrical energy for the motor is delivered to the motor via the cable device. Specifically, the cable device includes first and second cables wound in opposite directions around the drum and each connected at its drum end to a brush carried by the drum with each brush electrically coacting with a slip ring carried by the carrier and electrically connected to the respective terminals of the motor. Power for the motor thus extends along the cables to the brushes, through the brushes to the slip rings, and through the slip rings to the motor.

### FIELD OF THE INVENTION

This invention relates to window regulators for motor vehicles and more particularly to an arrangement for supplying electrical power to the motor of a window regulator.

### BACKGROUND OF THE INVENTION

Window regulators have typically employed a moving carrier carrying the glass and a motor fixed in the door and arranged to power the carrier. More recently there has been a trend to fix the motor to the carrier in such a way that it travels with the carrier and the glass. This improves the overall efficiency of the system, but has a negative impact on system reliability. Specifically, as the motor moves up and down so does the power cord providing electrical power to the motor, and repeated cable movement creates fatigue in the wire of the cord which leads to premature failure resulting in reduced system reliability and a higher warranty cost to the automaker and the consumer.

### SUMMARY OF THE INVENTION

This invention is directed to the provision of improved window regulator for a motor vehicle.

More specifically, this invention is directed to the provision of improved reliability in a window regulator of the type wherein the motor travels with the carrier.

This invention relates to the motor vehicle door window glass regulator of the type including a carrier for mounting the window glass and mounted for reciprocal movement to move the window glass between raised and lowered positions in the door, an electric motor carried by the carrier, and a cable device driven by the motor operative in response to actuation of the motor to move the carrier reciprocally and thereby move the window glass between its raised and lowered positions.

According to the invention the electrical energy for the motor is delivered to the motor via the cable device. This arrangement eliminates the cord fatigue problems encountered with a typical power cord extending to the motor and simplifies the regulator design.

According to a further feature of the invention, the cable device is wound around a cable drum driven by the motor and carried by the carrier and the cable device is electrically connected to brushes in the cable drum. This arrangement facilitates the delivery of electrical power via the cable device.

According to a further feature of the invention, the brushes engage slip rings which are electrically connected to the motor. This arrangement further facilitates the delivery of electrical power from the cable device to the motor.

According to a further feature of the invention, the cable device comprises a first cable wound at one end thereof around the drum, electrically connected at the one end thereof to a first brush, fixedly connected at another, free end thereof to a first fixed point on the door, and electrically connected at the free end thereof to a source of electrical energy, and a second cable wound at one end thereof around the drum, electrically connected at the one end thereof to a second brush, fixedly connected to another free end thereof to a second fixed point on the door, and electrically connected at the free end thereof to the source of electrical energy. This effectively and efficiently delivers electrical power to the motor via the cable in a two cable system.

According to the further feature of the invention, the regulator further includes a vertical rail for mounting in the door and the carrier is slidably mounted on the rail and moves up and down on the rail via the winding and unwinding of the cables on the drum in response to energization of the motor.

According to a further feature of the invention, the cable device comprises a cable including a wire formed of a bimetallic material including a first material to enhance tensile strength and a second material to enhance electrical conductivity.

According to further feature of the invention the cable further includes an insulative sheet encasing the wire.

### BRIEF DESCRIPTION OF THE DRAWINGS

The description herein makes reference to the accompanying drawings wherein like reference numerals refer to like parts throughout the several views, and wherein:

FIG. 1 is a side elevational, somewhat schematic view of a window regulator according to the invention;

FIG. 2 is a detail view taken within the circle 2 of FIG. 1;

FIG. 3 is a cross sectional view of a drum, slip ring, and brush assembly utilized in the regulator;

FIG. 4 is an exploded, perspective view of the drum, slip ring, and brush assembly;

FIGS. 5 and 6 are views of opposite sides of the drum; and

FIG. 7 is a fragmentary view showing details of the drum and a cable driving the drum.

### DETAILED DESCRIPTION OF THE PREFERRED EMBODIMENT

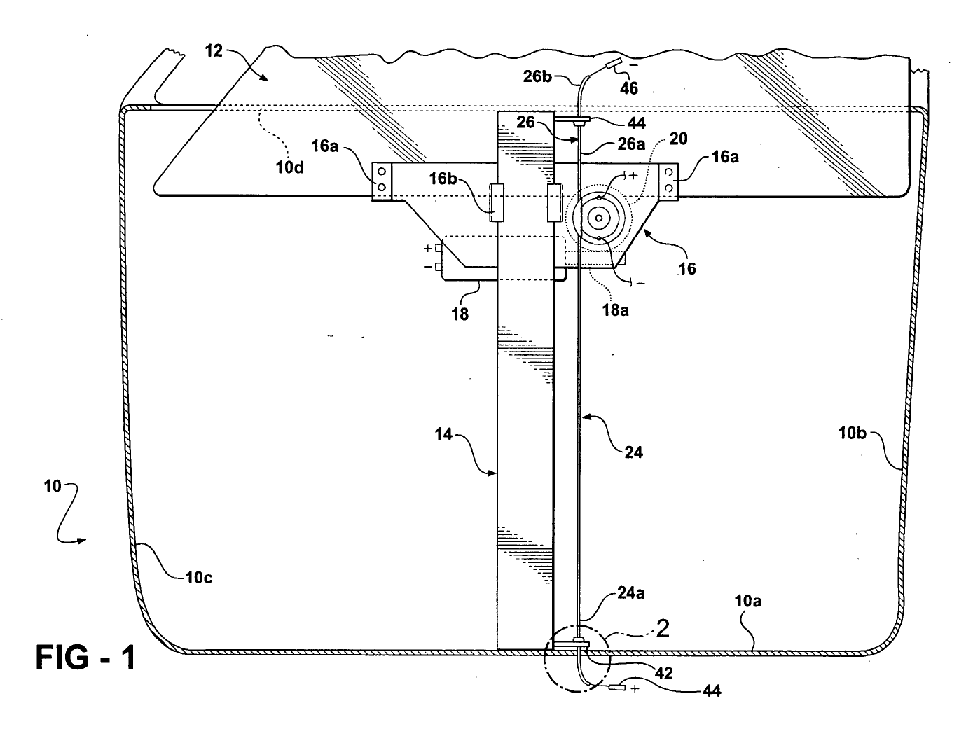

The window regulator of the invention as seen in FIG. 1 in association with a schematically shown motor vehicle door 10 having a frame structure 10a, 10b, 10c, and 10d and a window glass 12 arranged for reciprocal movement relative to the frame structure between raised and lowered positions.

The window regulator, broadly considered, includes a guide rail 14 extending vertically between door frame sections 10a and 10d, a carrier 16 having lug portion 16a fixedly secured to a lower region 12a of the window glass and guided for reciprocal sliding movement up and down the rail 14 by guide hooks 16b engaging opposite vertical edge faces of the rail; an electric motor 18 mounted on the carrier and having an output shaft 18a; a speed reduction gear 20 driven by the motor output shaft 18a and having an output shaft 20a journaled in the carrier 16; a drum 22 mounted on and driven by the output shaft 20a of the reduction gearing 20; a cable 24 wound in clockwise fashion around the drum 24 and fixed at its lower end 24a to rail 14 proximate door frame section 10a; a further cable 26 wound in counterclockwise fashion around the drum 22 and fixed at its upper end 26a to rail 14 proximate door frame section 10d; a pair of brushes 28, 30; and a pair of slip rings 32, 34.

It will be understood that, in operation of the window regulator, energization of the motor 18 has the effect of turning the drum 22 to wind and unwind the cables 24 and 26 and thereby move the carrier 16, and the window glass 12, upwardly and downwardly along the guide rail 14 to move the window glass between raised and lowered positions.

Drum 22 is formed of a suitable plastics material, has a generally cylindrical configuration, defines a helical cable groove 22a at its outer periphery and includes a splined central bore 22b for driving receipt of a splined outboard portion of reduction gear output shaft 20a.

Drum 22 further includes bores 22c and 22d extending through the drum. One side face 22e of the drum includes a groove 22f communicating with the drum helical groove 22c and further communicating with a socket 22g, a further groove 22h extending between the socket 22g and the bore 22c, and a further groove 22i extending between bore 22d and a further through bore 22j. The other side face 22k of the drum includes a groove 22l communicating with drum helical groove 22a and extending to bore 22j.

The end 24b of cable 24 proximate the drum is provided with a nipple 24c, sized to fit in socket 22g, and a terminal 24d.

The end 26b of cable 26 proximate the drum is provided with a nipple 26c, sized to fit in socket 22j, and a terminal 26d.

Brush 28 is formed of an electrically conductive material, has a cylindrical configuration sized to fit slidably in drum bore 26c, and includes a lead or tail 28a terminating in a terminal 28b.

Brush 30 is formed of a suitable electrically conductive material, has a cylindrical configuration sized to fit slidably in bore 22d, and includes a lead or tail 30a terminating in a terminal 30b.

Slip rings 34 and 32 are formed of electrically conductive material and are positioned in concentric relation on the inner face 16a of a cover portion 16b of the carrier 16.

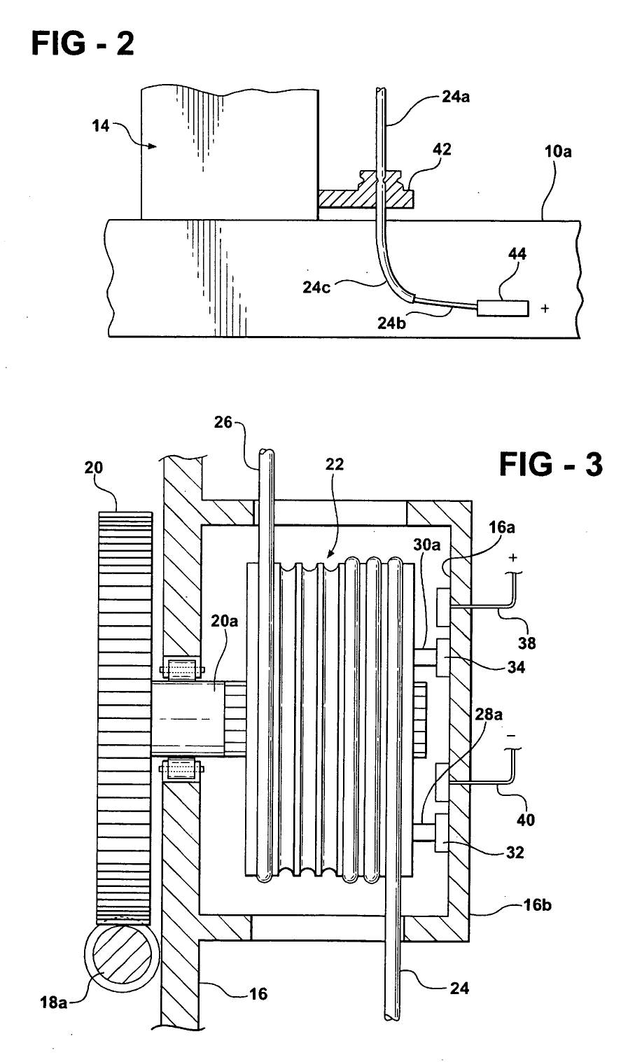

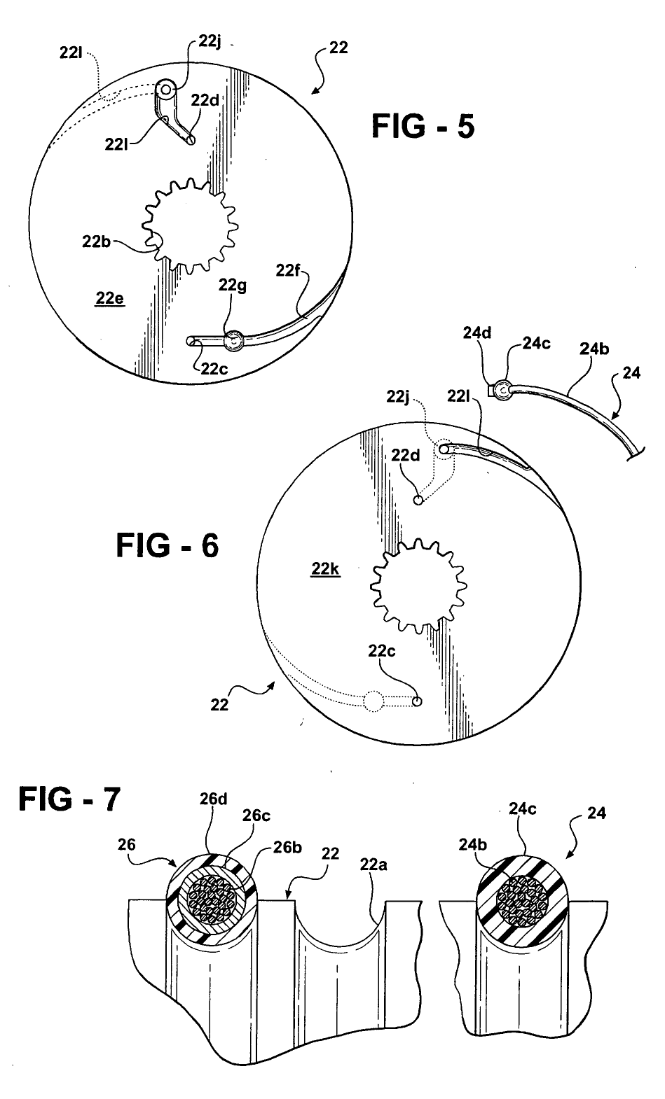

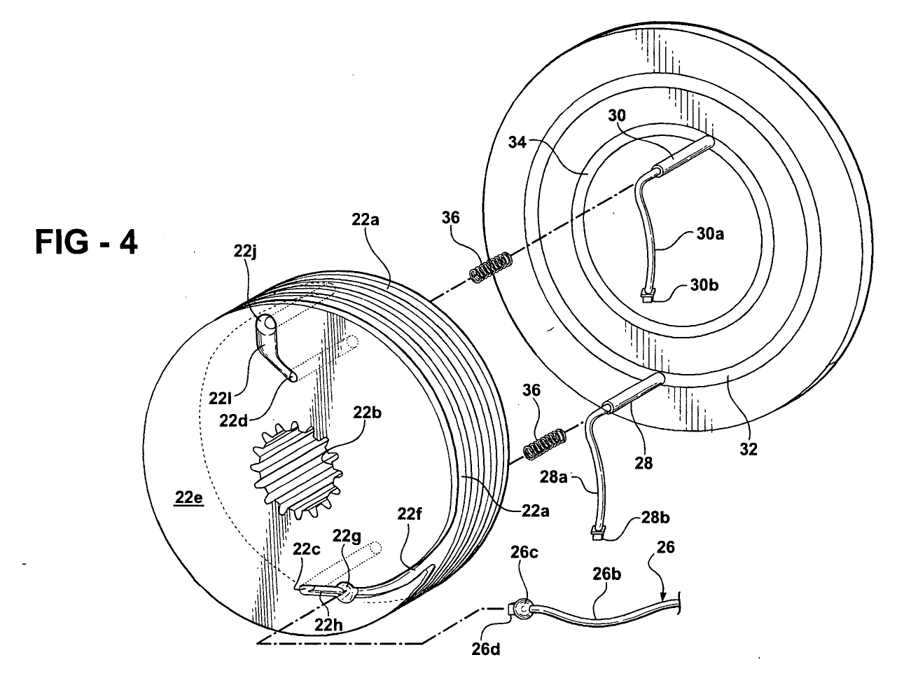

As seen with reference to cable 24 in FIG. 2, the cable may comprise a central multi-strand steel core wire 24b encased in an insulative sheath 24c. Alternatively, as seen with reference to cable 26 in FIG. 2, the cable may comprise a central multi-strand steel core wire 26b to provide tensile strength, a copper cladding 26c encasing the core steel wire to enhance conductability, and an insulative sheath 26d.

In the assembly relation of the parts, cable 26 extends downwardly from fixed end 26a and wraps in clockwise fashion around drum 22 in groove 22a and terminates in end 26b which is positioned in groove 22f in drum side face 22e with nipple 26c positioned in socket 22g; cable 24 extends upwardly from fixed end 24a and wraps in counterclockwise fashion around drum 22 in groove 22a and terminates in end 24b which is positioned in groove 24l in drum side face 22k with nipple 24c positioned in socket 22j; brush 28 is slidably positioned in drum bore 22c with lead 28a positioned in groove 22h and terminal 28b electrically connected to terminal 26d; brush 30 is slidably positioned in bore 22d with lead 30a positioned in groove 22i and then extending through bore 22j to position terminal 30b proximate terminal 26d and allow electrical connection of terminal 30b to terminal 24d; free ends 28a, 30a of the brushes 28, 30 are pressed against slip rings 32, 34, respectively, by springs 36 positioned in bores 22d, 22c in surrounding relation to the respective brushes; and the slip rings 32, 34 are respectively, suitably electrically connected to leads 38, 40 which are suitably routed to the positive and negative terminals of the motor 18.

The lower end 24a of cable 24 is fixedly secured in a fitting 42 secured to rail 14 with the conductive central core wire 24b of the cable secured to a terminal 44 for connection to a suitable source of electrical energy. Similarly, the upper end 26a of cable 26 is fixedly secured in a fitting 44 secured to the upper end of rail 14 with the central conductive wire 26b of the cable terminating in a terminal 46 for securement to a suitable source of electrical energy.

In operation, electrical energy is constantly supplied to motor 18 via the cables 24, 26 to provide reversible operation of the motor to move the carrier and the glass up and down between raised and lowered positions. Specifically, power extends from terminal 44 upwardly through cable 24 to terminal 24d; thereafter proceeds through lead 38a to brush 30; thereafter proceeds from brush 30 to slip ring 32; and thereafter proceeds through lead 38 to a first terminal of the motor. Similarly, opposite polarity energy extends from terminal 46 downwardly through cable 26 to terminal 26d; thereafter proceeds through lead 28a to brush 28; thereafter proceeds through brush 28 to slip ring 34; and thereafter proceeds through lead 40 to the other terminal of the motor.

The invention will be seen to provide power to a motor mounted on the window regulator carrier while avoiding the problem of cord fatigue and failure resulting from the constant flexing and/or pinching of the cord as the carrier and window glass repeatedly move upwardly and downwardly between the raised and lowered positions.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A motor vehicle door window glass regulator of the type including a carrier for mounting the window glass and mounted for reciprocal movement to move the window glass between raised and lowered positions in the door, an electric motor carried by the carrier, and a cable device driven by the motor and operative in response to actuation of the motor to move the carrier reciprocally and thereby move the window glass between its raised and lowered positions, characterized in that:
the electrical energy for the motor is delivered to the motor via the cable device.

2. A motor vehicle window glass regulator according to claim 1 wherein:
the cable device is wound around a cable drum driven by the motor and carried by the carrier; and
the cable device is electrically connected to brushes in the cable drum.

3. A motor vehicle window glass regulator according to claim 2 wherein the brushes engage slip rings which are electrically connected to the motor.

4. A motor vehicle window glass regulator according to claim 3 wherein the cable device comprises:
a first cable wound at one end thereof around the drum, electrically connected at the one end thereof to a first brush, fixedly connected at another, free end thereof to a first fixed point on the door, and electrically connected at the free end thereof to a source of electrical energy; and
a second cable wound at one end thereof around the drum, electrically connected at the one end thereof to a second brush, fixedly connected at another, free end thereof to a second fixed point on the door, and electrically connected at the free end thereof to the source of electrical energy.

5. A motor vehicle window glass regulator according to claim 4 wherein:
the regulator further includes a vertical rail for mounting in the door; and
the carrier is slidably mounted on the rail and moves up and down on the rail via the winding and unwinding of the cables on the drum in response to energization of the motor.

6. A motor vehicle window glass regulator according to claim 1 wherein:
the regulator further includes a vertical rail mounted in the door; and
the carrier is mounted for vertical movement on the rail in response to energization of the motor via the electrical energy delivered to the motor via the cable device.

7. A motor vehicle window glass regulator according to claim 1 wherein the cable device comprises a cable including a wire formed of a bi-metallic material including a first material to enhance tensile strength and a second material to enhance electrical conductivity.

8. A motor vehicle window glass regulator according to claim 7 wherein the cable further includes an insulative sheet encasing the wire.

9. A motor vehicle door window glass regulator comprising:
a carrier for mounting the window glass and mounted for reciprocal movement to move the window glass between raised and lowered positions in the door;
an electric motor carried by the carrier;
a cable device driven by the motor and operative in response to actuation of the motor to move the carrier reciprocally and thereby move the window glass between its raised and lowered positions;
means connecting the cable device to a source of electrical energy; and
means for delivering electrical energy from the cable device to the motor.

10. A motor vehicle door window glass regulator according to claim 9 wherein:
the regulator further includes a drum driven by the motor;
the cable device includes a first cable wound at one end thereof around the drum and fixedly connected at another, free end thereof to a first fixed point on the door;
the connecting means includes means electrically connecting the free end of the first cable to the source of electrical energy; and
the delivering means includes means electrically connecting the one end of the first cable to a first terminal on the motor.

11. A motor vehicle door widow glass regulator according to claim 10 wherein:
the cable device further includes a second cable wound at one end thereof around the drum and fixedly connected at another free end thereof to a second fixed point on the door;
the connecting means further includes means electrically connecting the free end of the second cable to the source of the electrical energy; and
the delivering means further includes means electrically connecting the one end of the second cable to a second terminal of the motor.

12. A motor vehicle door window glass regulator according to claim 11 wherein:
the means electrically connecting the one ends of the first and second cables to the respective first and second terminals of the motor comprise brushes electrically connected to the one ends of the cable engaging slip rings electrically connected to the motor terminals.

13. A motor vehicle door window glass regulator according to claim 9 wherein the cable device comprises a cable including a wire formed of a bimetallic material including a first material to enhance tensile strength and a second material to enhance electrical conductivity.

14. A motor vehicle door window glass regulator according to claim 13 wherein the cable further includes an insulative sheet encasing the wire.

15. A motor vehicle door window glass regulator according to claim 12 wherein the brushes are carried by the drum.
